(19) United States
(12) Patent Application Publication
(10) Pub. No.: US 2009/0058356 A1
(43) Pub. Date: Mar. 5, 2009

(54) MULTI-CHARGING DEVICE AND METHOD

(75) Inventors: Yong-Whi LEE, Seoul (KR); Jung-Kyu KIM, Yongin-si (KR); Jae-Sam YOUN, Suwon-si (KR); Young-Mok JEUN, Seoul (KR); Young-Jin YI, Yongin-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/169,004

(22) Filed: Jul. 8, 2008

(30) Foreign Application Priority Data
Aug. 27, 2007 (KR) 10-2007-0086092

(51) Int. Cl. H02J 7/00

(52) U.S. Cl. 320/106; 320/107

(57) ABSTRACT

Provided is a multi-charging device and method by which a plurality of portable-device batteries can be charged simultaneously. The multi-charging device includes charging terminal connector including a socket to receive power from an external source and a plurality of charging terminals. Each charging terminal is connected with the charging terminal connector, and the charging terminals deliver the power from the socket of the charging terminal connector to a portable device connected therewith.

### CROSS-REFERENCE TO RELATED PATENT APPLICATION

This application claims priority from and the benefit of Korean Patent Application No. 10-2007-0086092, filed on Aug. 27, 2007, which is hereby incorporated by reference for all purposes as if fully set forth herein.

### BACKGROUND OF THE INVENTION

1. Field of the Invention

The present invention relates to battery charging, and in particular, to a multi-charging device and method by which a plurality of portable-device batteries may be charged simultaneously.

2. Discussion of the Background

Portable devices refer to devices that are easy to carry and provide particular functions to users. For example, portable devices include portable terminals providing various functions such as a communication function, an electronic note-taking function, a camera function, and a music play function. Bluetooth® ear sets wirelessly provide audio to users using Bluetooth® communication methods, and Moving Picture Experts Group (MPEG)-1 Audio Layer 3 (MP3) players play MP3 files in an audio file format.

Portable devices have batteries and are provided with electric energy from the batteries. When the electric energy charged in the battery is less than a set level, a charging device may be used to re-charge the battery. For example, a general purpose 24-pin plug may be used to charge the battery of a portable terminal, and a circular plug may be used to charge the battery of a Bluetooth® ear set.

However, different types of portable devices may need to be charged using different chargers and the number of pins of the charging plugs to connect the portable device with the corresponding charger may differ from device to device. More specifically, a general-purpose 24-pin plug may be used to charge the battery of a portable terminal and a circular plug may be used to charge the battery of a Bluetooth® ear set, as mentioned above.

Moreover, a charger for a portable device may not be able to simultaneously charge batteries of multiple portable devices. In other words, since a charger having a 24-pin plug has only one 24-pin plug, it may be able to charge only the battery of a portable terminal and may not be able to also charge a battery of another portable terminal or an extra battery at the same time.

### SUMMARY OF THE INVENTION

The present invention provides a charging device and method by which batteries of portable devices of different types may be charged using a single charging device.

The present invention also provides a charging device and method by which batteries of a plurality of portable devices may be simultaneously charged using a single charging device.

Additional features of the invention will be set forth in the description which follows, and in part will be apparent from the description, or may be learned by practice of the invention.

The present invention discloses a multi-charging device including a charging terminal connector including a socket to receive power from an external source and a plurality of charging terminals. Each charging terminal is connected to the charging terminal connector, and the charging terminals deliver power from the socket of the charging terminal connector to a portable device connected therewith.

The present invention also discloses a multi-charging method for a multi-charging device. The multi-charging method includes checking if a particular charging terminal among a plurality of charging terminals is connected with a portable device, and delivering power provided from an external source to the portable device if the particular charging terminal is connected with the portable device.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a Multi-Chargeable Tab (MCT) according to an exemplary embodiment of the present invention.

FIG. 2 shows an example of the MCT according to an exemplary embodiment of the present invention.

FIG. 3 is a circuit block diagram of the MCT according to an exemplary embodiment of the present invention.

FIG. 4 is a circuit block diagram of a power supply unit according to an exemplary embodiment of the present invention.

FIG. 5 is a flowchart showing a process in which the MCT charges a battery according to an exemplary embodiment of the present invention.

FIG. 6 shows an example of the use of the MCT according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

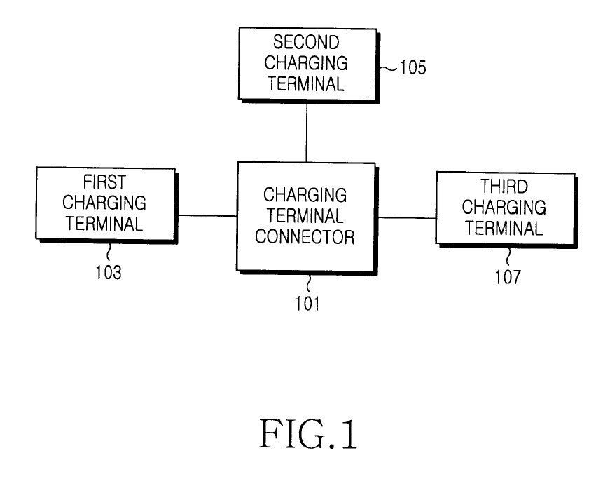

FIG. 1 is a block diagram of a Multi-Chargeable Tab (MCT) according to an exemplary embodiment of the present invention.

Referring to FIG. 1, the MCT includes a charging terminal connector 101 and a plurality of charging terminals, e.g., a first charging terminal 103, a second charging terminal 105, and a third charging terminal 107. The first charging terminal 103, the second charging terminal 105, and the third charging terminal 107 may be connected with a portable device to charge a battery of the portable device.

Each of the first charging terminal 103, the second charging terminal 105, and the third charging terminal 107 is connected with the charging terminal connector 101, and when a battery is coupled with a charging terminal, power supplied by the charging terminal connector 101 may be delivered to the battery.

Each of the first charging terminal 103, the second charging terminal 105, and the third charging terminal 107 includes a battery charging plug whose type is determined by the type of a battery charging socket included in the portable device. For example, a charging terminal to charge a portable device having a 24-pin socket as the battery charging socket may include a 24-pin plug, and a charging terminal to charge a portable device having a circular jack as the battery charging socket may include a circular plug. As another example, a charging terminal to charge a portable device having a circular jack as the battery charging socket may have a circular plug, and a charging terminal to charge a portable device having a Universal Serial Bus (USB) port as the battery charging socket may include an USB plug.

The charging terminal connector 101 is connected with the first charging terminal 103, the second charging terminal 105, and the third charging terminal 107, and is provided with power from an external source. When a battery is coupled with at least one of the first charging terminal 103, the second charging terminal 105, and the third charging terminal 107, the charging terminal connector 101 supplies the provided power to the charging terminal having the battery of the portable device coupled thereto.

If a target voltage and a target current of power to be supplied to one of the first charging terminal 103, the second charging terminal 105, and the third charging terminal 107 are different from those of the power provided from an external source, the charging terminal connector 101 may supply the power after converting the voltage and the current of the power into a target voltage and a target current. For example, if a voltage and a current of the provided power are 4.2 V and 750 mA and the target voltage and the target current of power to be supplied to the second charging terminal 105 are 5.1 V and 400 mA, the charging terminal connector 101 may convert the power corresponding to the voltage of 4.2 V and the current of 750 mA to correspond to the voltage of 5.1 V and the current of 400 mA and then supply the converted power to the second charging terminal 105.

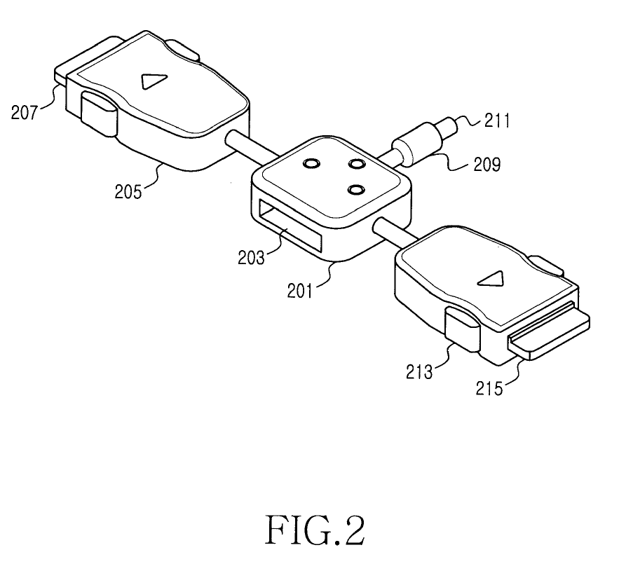

FIG. 2 shows an example of the MCT according to an exemplary embodiment of the present invention.

Referring to FIG. 2, the MCT includes a charging terminal connector 201 having a 24-pin socket 203, a first charging terminal 205 connected with the charging terminal connector 201 and has a 24-pin plug 207, a second charging terminal 209 connected with the charging terminal connector 201 and having a circular plug 211, and a third charging terminal 213 connected with the charging terminal connector 201 and having a 24-pin plug 215.

The first charging terminal 205 and the third charging terminal 213 each include a 24-pin plug 207 and 215 for connection with a portable device having a 24-pin socket for battery charging. For example, the first charging terminal 205 and the third charging terminal 213 may be used to charge a battery of a portable terminal. The portable terminal refers to a terminal having various functions such as a communication, an electronic note-taking function, and so on, and may be a cellular phone, a Personal Digital Assistant (PDA), or the like.

The second charging terminal 209 includes the circular plug 211 for connection with a portable device having a circular jack for battery charging. For example, the second charging terminal 209 may be used to charge a battery of a Bluetooth® ear set.

The charging terminal connector 201 includes the dedicated supply 24-pin socket 203 that is provided with power from an external source. When the dedicated supply 24-pin socket 203 is connected with a portable-terminal charger, the charging terminal connector 201 delivers power provided from the portable terminal charger to the first charging terminal 205, the second charging terminal 209, and the third charging terminal 213. The portable terminal charger refers to a charger for charging a portable terminal that has a 24-pin plug according to standards established by the Ministry of Information and Communication (Republic of Korea).

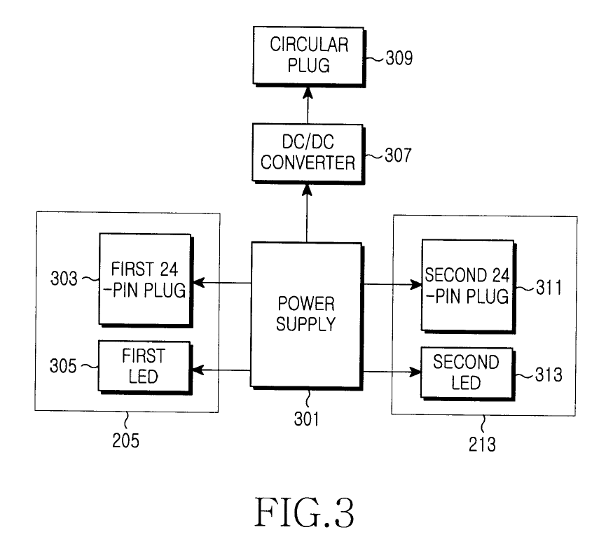

FIG. 3 is a circuit block diagram of the MCT according to an exemplary embodiment of the present invention.

Referring to FIG. 3, the MCT includes a power supply unit 301 and a Direct Current (DC)/DC converter 307 in the charging terminal connector 201, a first 24-pin plug 303 and a first Light Emitting Diode (LED) 305 in the first charging terminal 205, a circular plug 309 in the second charging terminal 209, and a second 24-pin plug 311 and a second LED 313 in the third charging terminal 213.

The first 24-pin plug 303 connects a portable device with the power supply unit 301. In particular, according to an exemplary embodiment of the present invention, when the first 24-pin plug 303 is connected with a portable device, it is provided with power from the power supply unit 301 and delivers the power to the connected portable device. For example, if the first 24-pin plug 303 is connected with a battery charging 24-pin socket of a portable terminal, it delivers power provided from the power supply unit 301 to a battery of the portable terminal, thereby charging the battery of the portable terminal.

The first LED 305 emits different colors under the control of the power supply unit 301. For example, when a portable device is connected with the first 24-pin plug 303 to charge the battery of the portable device, the first LED 305 may receive a red light emitting signal from the power supply unit 301 and may emit a red light according to the received red light emitting signal. When the charging is finished, the first LED 305 may receive a green light emitting signal from the power supply unit 301 and may emit a green light according to the received green light emitting signal. Thus, the first LED 305 may emit the red light or the green light according to a battery charging state of the portable device connected with the first 24-pin plug 303.

The DC/DC converter 307 converts power provided from the power supply unit 301 into a designated power and transmits the converted power to the circular plug 309. For example, when the DC/DC converter 307 is set to output power corresponding to 5.1 V and 400 mA, it may convert power corresponding to 4.2 V and 750 mA into power corresponding to 5.1 V and 400 mA, and then may transmit the converted power to the circular plug 309.

The circular plug 309 connects a portable device with the DC/DC converter 307. In particular, according to an exemplary embodiment of the present invention, when the circular plug 309 is connected with a portable device, it is provided with power from the DC/DC converter 307 and delivers the provided power to the currently connected portable device. For example, if the circular plug 309 is connected with a battery charging circular jack of a Bluetooth® ear set, it delivers power provided from the DC/DC converter 307 to a battery of the Bluetooth® ear set, thereby charging the battery of the Bluetooth® ear set.

The second 24-pin plug 311 connects a portable device with the power supply unit 301. In particular, according to an exemplary embodiment of the present invention, when the second 24-pin plug 311 is connected with a portable device, it is provided with power from the power supply unit 301 and delivers the provided power to the currently connected portable device. For example, if the second 24-pin plug 311 is connected with a battery charging 24-pin socket of a portable terminal, it delivers power provided from the power supply unit 301 to a battery of the portable terminal, thereby charging the battery of the portable terminal.

The second LED 313 emits different colors under the control of the power supply unit 301. For example, when a portable device is connected with the second 24-pin plug 311 to charge the battery of the portable device, the second LED 313 may receive the red light emitting signal from the power supply unit 301 and may emit red light according to the received red light emitting signal. When the charging is finished, the second LED 313 may receive a green light emitting signal from the power supply unit 301 and may emit green light according to the received green light emitting signal. Thus, the second LED 313 may emit red light or green light according to a battery charging state of the portable device connected with the second 24-pin plug 311.

The power supply unit 301 supplies power to portable devices connected with the first 24-pin plug 303, the circular plug 309, and the second 24-pin plug 311, and controls the first LED 305 according to the battery charging state of the portable device connected with the first 24-pin plug 303 and the second LED 313 according to the battery charging state of the portable device connected with the 24-pin second plug 311.

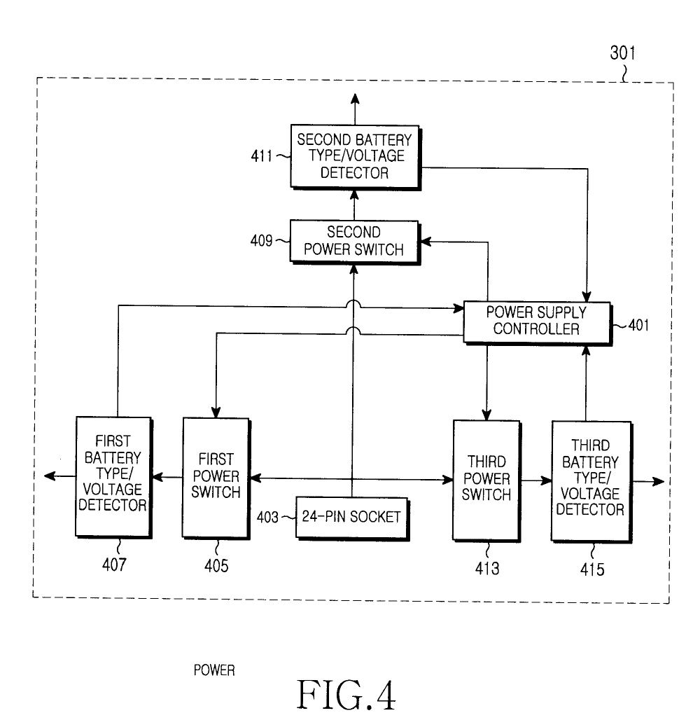

The power supply unit 301 will now be described in more detail with reference to FIG. 4. Referring to FIG. 4, the power supply unit 301 includes a power supply controller 401, a 24-pin socket 403, a first power switch 405, a first battery type/voltage detector 407, a second power switch 409, a second battery type/voltage detector 411, a third power switch 413, and a third battery type/voltage detector 415.

The 24-pin socket 403 receives power from a portable terminal charger when connected with the portable terminal charger, and delivers the power to the first power switch 405, the second power switch 409, and the third power switch 413. For example, the 24-pin socket 403 may receive power corresponding to 4.2 V and 750 mV from a portable terminal charger and may deliver the received power to the first power switch 405, the second power switch 409, and the third power switch 413.

The first power switch 405 controls the delivery of power from the 24-pin socket 403 to the first 24-pin plug 303 via the first battery type/voltage detector 407 under the control of the power supply controller 401. For example, under the control of the power supply controller 401, power from the 24-pin socket 403 may be delivered to the first 24-pin plug 303 when the first power switch 405 is in an ON state and power may not be delivered to the first 24-pin plug 303 when the first power switch 405 is in an OFF state. An ON state refers a switch-open state and an OFF state refers a switch-closed state.

The first battery type/voltage detector 407 detects a type and a current voltage of a battery of a portable device connected with the first 24-pin plug 303. For example, if a portable device is connected with the first 24-pin plug 303, the first battery type/voltage detector 407 may detect a voltage of a battery of the connected portable device and may output the detected voltage to the power supply controller 401.

The second power switch 409 controls the delivery of power from the 24-pin socket 403 to the circular plug 309 via the second battery type/voltage detector 411 under the control of the power supply controller 401. For example, under the control of the power supply controller 401, power may be delivered from the 24-pin socket 403 to the circular plug 309 when the second power switch 409 is in an ON state and power may not be delivered to the circular plug 309 when the second power switch 409 is in an OFF state.

The second battery type/voltage detector 411 detects a type and a current voltage of a battery of a portable device connected with the circular plug 309. For example, if a portable device is connected with the circular plug 309, the second battery type/voltage detector 411 may detect a voltage of a battery of the connected portable device and may output the detected voltage to the power supply controller 401.

The third power switch 413 may control the delivery of power from the 24-pin socket 403 to the 24-pin second plug 311 via the third battery type/voltage detector 415 under the control of the power supply controller 401. For example, under the control of the power supply controller 401, power may be delivered from the 24-pin socket 403 to the 24-pin second plug 311 when the third power switch 413 is in an ON state and power may not be delivered to the 24-pin second plug 311 when the third power switch 413 is in an OFF state.

The third battery type/voltage detector 415 detects a type and a current voltage of a battery of a portable device connected with the 24-pin second plug 311. For example, if a portable device is connected with the 24-pin second plug 311, the third battery type/voltage detector 415 may detect a voltage of a battery of the connected portable device and may output the detected voltage to the power supply controller 401.

The power supply controller 401 receives power from the 24-pin socket 403 and supplies the received power to the first 24-pin plug 303, the circular plug 309, and the second 24-pin plug 311. More specifically, the power supply controller 401 checks if a portable device is connected with one of the first 24-pin plug 303, the circular plug 309, and the second 24-pin plug 311. If so, the power supply controller 401 switches a power switch connected with the connected plug to the ON state to supply the power from the 24-pin socket 403 to the connected plug. If an LED exists in the connected plug, the power supply controller 401 outputs a red light emitting signal for emitting red light to the LED to control the LED to emit red light.

The power supply controller 401 receives the battery type and the current battery voltage detected by a battery type/voltage detector connected with the particular plug. The power supply controller 401 recognizes a battery rated voltage according to the input battery type and compares the current input battery voltage with the recognized battery rated voltage. If the current battery voltage is equal to or greater than the battery rated voltage, the power supply controller 401 recognizes that battery charging for the portable device connected with the particular plug has been completed and turns off the power switch connected with the particular plug so that power received from the 24-pin socket 403 is not supplied to the particular plug. If an LED exists in the particular plug, the power supply controller 401 outputs a green light emitting signal for emitting green light to the LED to control the LED to emit green light.

During battery charging or after completion of battery charging, the power supply controller 401 checks if the connection between the particular plug and the portable device is released. If so, the power supply controller 401 turns off the power switch connected with the particular plug so that power from the 24-pin socket 403 is not supplied to the particular plug. If an LED exists in the particular plug, the power supply controller 401 outputs a non-light emitting signal to stop light emission of the LED to the LED to control the LED to stop light emission.

For example, when a portable device is coupled with the first 24-pin plug 303, the power supply controller 401 may switch the first power switch 405 connected with the first 24-pin plug 303 to the ON state and may supply the power received from the 24-pin socket 403 to the first 24-pin plug 303. The power supply controller 401 may then output the red light emitting signal to the first LED 305 in order to control the first LED 305 to emit the red light. The power supply controller 401 may also compare a battery voltage input from the first battery type/voltage detector 407 with a reference battery voltage. If the input battery voltage is equal to or greater than the reference battery voltage, the power supply controller 401 may recognize that battery charging has been completed and thus may switch the first power switch 405 to the OFF state. The power supply controller 401 may then output the green light emitting signal to the first LED 305 to control the first LED 305 to emit the green light. When the connection between the first 24-pin plug 303 and the portable device is released during battery charging or after completion of battery charging, the power supply controller 401 may switch the first power switch 405 to the OFF state. The power supply controller 401 may output the non-light emitting signal to the first LED 305 to control the first LED 305 to stop light emission.

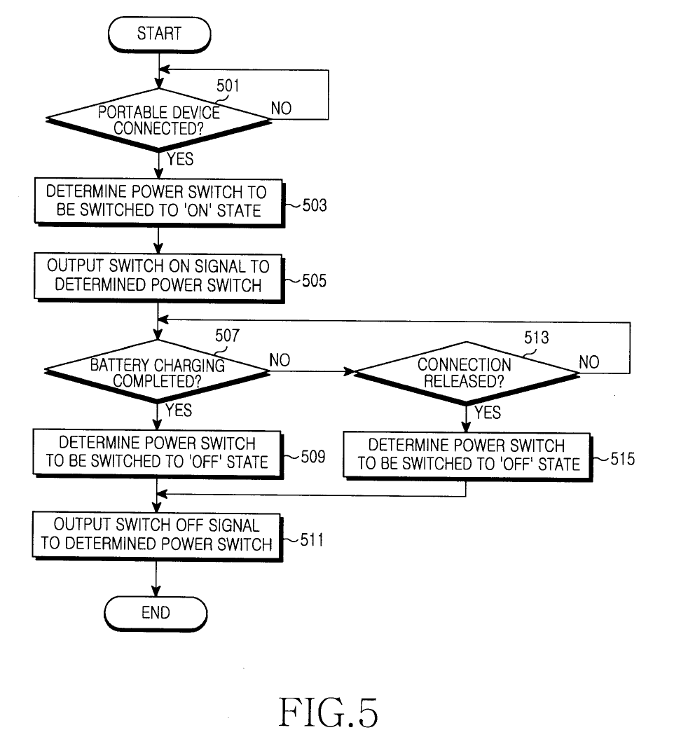

FIG. 5 is a flowchart showing a process in which the MCT charges a battery according to an exemplary embodiment of the present invention.

Referring to FIG. 5, in step 501, the power supply controller 401 checks if a particular one of the first 24-pin plug 303, the circular plug 309, and the second 24-pin plug 311 is connected with a portable device. The power supply controller 401 goes to step 503 if at least one of them is connected with a portable device, and repeats step 501 if any one of them is not connected with the portable device.

In step 503, the power supply controller 401 determines whether a power switch is to be switched to the ON state by checking if there is a power switch connected with the particular plug and then goes to step 505. In step 505, the power supply controller 401 outputs a switch ON signal to the determined power switch to switch the power switch to the ON state, and then goes to step 507.

In step 507, the power supply controller 401 checks if charging of a battery of the connected portable device has been completed. If so, the power supply controller 401 goes to step 509. If not, the power supply controller 401 goes to step 513.

For example, the power supply controller 401 may receive a battery type and a current voltage from a battery type/voltage detector connected with the particular plug and may recognize a battery rated voltage using the received battery type. The power supply controller 401 may compare a current battery voltage with the recognized rated battery voltage. If the current battery voltage is greater than or equal to the rated battery voltage, the power supply controller 401 may recognize that battery charging for the connected portable device has been completed and may go to step 509. If the current battery voltage is less than the rated battery voltage, the power supply controller 401 may recognize that the battery charging has not yet been completed and go to step 513.

In step 509, the power supply controller 401 determines whether a power switch is to be switched to an OFF state by checking if there is a power switch associated with the battery-charged portable device, and then goes to step 511.

In step 513, the power supply controller 401 checks if the connection between the particular plug and the portable device is released. If so, the power supply controller 401 goes to step 515. If not, the power supply controller 401 goes to step 507.

In step 515, the power supply controller 401 determines whether a power switch is to be changed to the OFF state by checking if there is a power switch connected with the particular plug, and then goes to step 511.

In step 511, the power supply controller 401 outputs a switch OFF signal to the determined power switch in order to switch the determined power switch to the OFF state.

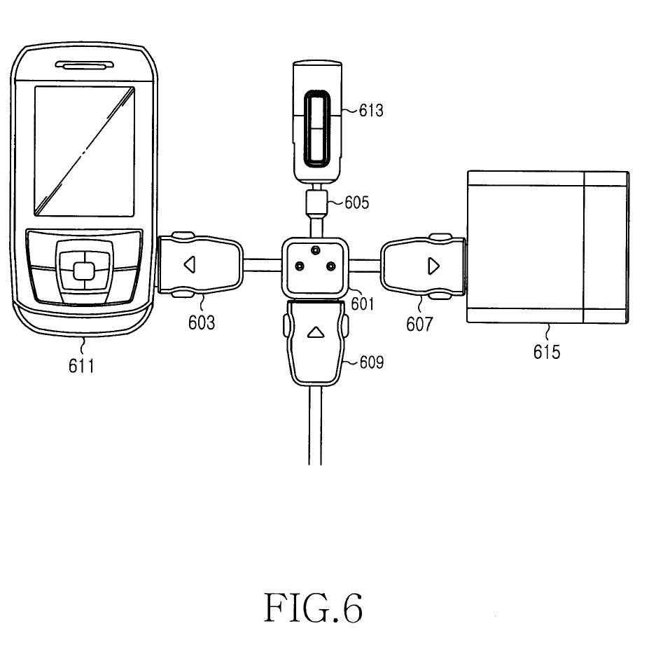

Referring to FIG. 6, the MCT includes a charging terminal connector 601, 24-pin charging terminals 603 and 607 connected with the charging terminal connector 601 at left and right sides of the charging terminal connector 601, and a circular charging terminal 605 connected with the charging terminal connector 601 at an upper side of the charging terminal connector 601. The 24-pin charging terminal 603 at the left side of the charging terminal connector 601 is connected with a portable terminal 611. The circular charging terminal 605 at the upper side of the charging terminal connector 601 is connected with a Bluetooth® ear set 613. The 24-pin charging terminal 607 at the right side of the charging terminal connector 601 is connected with an extra battery 615 for the portable terminal 611. A 24-pin charging socket 601 of the charging terminal connector 601 is connected with a portable-terminal charger 609.

The 24-pin charging terminals 603 and 607 and the circular charging terminal 605 are provided with power from the portable-terminal charger 609 via the charging terminal connector 601. Therefore, a portable device having a 24-pin socket mounted therein, e.g., the portable terminal 611 or the external battery 615 for the portable terminal 611, and a portable device charged using a circular terminal, e.g., the Bluetooth® ear set 613, can be charged at the same time.

In FIG. 6, the charging terminal connector 601 includes a pair of 24-pin charging terminals 603 and 607 and a single circular charging terminal 605. Thus, the MCT can simultaneously charge the portable terminal 611, the extra battery 615 for the portable terminal 611, and the Bluetooth® ear set 613.

As is apparent from the foregoing description, batteries of a plurality of different portable devices may be simultaneously charged using a single charging device.

It other exemplary embodiments of the present invention the MCT may include a pair of 24-pin charging terminals and a single USB charging terminal, a single 24-pin charging terminal and a pair of USB charging terminals, or a pair of 24-pin charging terminals and a single circular charging terminal may also be possible.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A multi-charging device, comprising:
a charging terminal connector comprising a socket to receive power from an external source; and
a plurality of charging terminals, each charging terminal being connected with the charging terminal connector,
wherein the charging terminals deliver the power from the socket of the charging terminal connector to a portable device connected with the charging terminals.

2. The multi-charging device of claim 1, wherein the socket is a 24-pin socket.

3. The multi-charging device of claim 2, wherein the plurality of charging terminals comprise a 24-pin charging terminal, a circular charging terminal, and a Universal Serial Bus (USB) charging terminal.

4. The multi-charging device of claim 1, wherein the charging terminal connector comprises battery type/voltage detectors and power switches connected with the plurality of charging terminals, respectively, and a power supply controller, and
the battery type/voltage detector detects a type and a current voltage of a battery of a portable device connected with a particular charging terminal among the plurality of charging terminals,
the power switches deliver the power or stop delivering the power to the charging terminals connected therewith according to ON/OFF states of the power switches, and
the power supply controller recognizes a rated voltage of the battery according to the detected battery type, compares the detected current voltage with the recognized rated voltage to recognize a charging state of the battery, and controls the power switches according to the recognized charging state.

5. The multi-charging device of claim 4, wherein the power supply controller recognizes a particular charging terminal connected with the portable device from among the plurality of charging terminals and switches a power switch connected with the particular charging terminal to the ON state to deliver the power to the particular charging terminal.

6. The multi-charging device of claim 5, wherein the power supply controller recognizes a particular charging terminal whose connection with the portable device is released from among the plurality of charging terminals and switches a power switch connected with the particular charging terminal to the OFF state to stop delivery of the power to the particular charging terminal.

7. The multi-charging device of claim 6, wherein the charging terminal connector further comprises a Direct Current (DC)/DC converter between the power switch and the particular charging terminal to convert the power delivered from the power switch and to deliver the converted power to the particular charging terminal.

8. The multi-charging device of claim 7, further comprising a light emitting diode in the particular charging terminal to emit a first-color light when the portable device is connected with the particular charging terminal, to emit a second-color light when charging of the battery of the portable device has been completed, and to stop light emission when the connection between the portable device and the particular charging terminal is released.

9. A multi-charging method for a multi-charging device, comprising:
checking if a particular charging terminal among a plurality of charging terminals is connected with a portable device; and
delivering power from an external source to the portable device if the particular charging terminal is connected with the portable device.

10. The multi-charging method of claim 9, wherein delivering power to the portable device comprises switching a power switch connected with the particular charging terminal to an ON state before delivering power to the portable device.

11. The multi-charging method of claim 9, wherein delivering power to the portable device comprises:
switching a power switch connected with the particular charging terminal to an ON state;
converting the power delivered through the power switch into power corresponding to a designated current and a designated voltage for the particular charging terminal; and
delivering the converted power to the particular charging terminal.

12. The multi-charging method of claim 10, further comprising:
detecting a type of a battery of the portable device;
recognizing a rated voltage of the battery according to the detected battery type;
detecting a current voltage of the battery and comparing the detected current voltage with the recognized rated voltage to check a charging state of the battery; and
switching the power switch to an OFF state to stop delivering the power to the portable device if charging of the battery has been completed.

13. The multi-charging method of claim 11, further comprising:
detecting a type of a battery of the portable device;
recognizing a rated voltage of the battery according to the detected battery type;
detecting a current voltage of the battery and comparing the detected current voltage with the recognized rated voltage to check a charging state of the battery; and
switching the power switch into an OFF state to stop delivering the power to the portable device if charging of the battery has been completed.

14. The multi-charging method of claim 9, further comprising:
checking if a connection between the portable device and the particular charging terminal is released; and
stopping delivery of power to the portable device if the connection is released.

15. The multi-charging method of claim 14, wherein stopping delivery of power comprises switching a power switch connected with the particular charging terminal to the OFF state to stop delivery of power to the portable device.

16. The multi-charging method of claim 15, further comprising notifying a user of a charging state of a battery of the portable device when the portable device is connected with the particular charging terminal.

17. The multi-charging method of claim 16, wherein the notifying a user of the charging state comprises:
emitting a first-color light through a Light Emitting Diode (LED) corresponding to the particular charging terminal when the battery of the portable device is being charged; and
emitting a second-color light through the LED when battery charging for the portable device has been completed.

18. The multi-charging method of claim 16, further comprising notifying a user when a connection between the portable device and the particular charging terminal is released.

19. The multi-charging method of claim 18, wherein notifying a user when a connection between the portable device and the particular charging terminal is released comprises stopping light emission of a light emitting diode that corresponds to the particular charging terminal.
